(19) United States
(12) Patent Application Publication
(10) Pub. No.: US 2026/0120153 A1
(43) Pub. Date: Apr. 30, 2026

(54) SELECTION FROM A SET OF MODELS TRAINED ON DIFFERENT DATASETS

(71) Applicant: Capital One Services, LLC, McLean, VA (US)

(72) Inventors: Abhilash GUPTA, Mandi Gobindgarh (IN); Abhinav GUPTA, Panchkula (IN); Abhishek TEWARI, Bengaluru (IN); Govind A, Kollam (IL); Koustubh DWIVEDY, Panchkula (IN); Kukumina PRADHAN, Bangalore (IN); Lokesh S. TULSHAN, Bangalore (IN); Ruchin RAJ, Noida (IN); Somak LAHA, Begampur (IN); Yatindra NATH, Bangalore (IN)

(21) Appl. No.: 18/932,282

(22) Filed: Oct. 30, 2024

(51) Int. Cl. G06Q 30/02

(52) U.S. Cl. CPC G06Q 30/0278

(57) ABSTRACT

In some implementations, a model system may receive an indication of the set of models that are associated with a set of data points. Each model in the set of models may have been selected using a grid search. The model system may receive, from a user device, a query associated with a selected data point in the set of data points. The selected data point may be associated with a corresponding model in the set of models. The model system may provide information included in the query to the corresponding model in order to receive a result associated with the selected data point. The model system may transmit, to the user device, the result in response to the query.

### BACKGROUND

Using machine learning models to estimate values (e.g., valuations for vehicles) is increasing in popularity. However, machine learning models generally have high computational cost, which tends to increase exponentially with improvements in accuracy.

### SUMMARY

Some implementations described herein relate to a system for selecting from a set of models. The system may include one or more memories and one or more processors communicatively coupled to the one or more memories. The one or more processors may be configured to receive a set of data points. The one or more processors may be configured to receive an indication of the set of models, wherein each model in the set of models was trained using a corresponding dataset in a set of datasets. The one or more processors may be configured to apply a grid search to the set of models in order to generate a set of selected models, wherein each data point from the set of data points corresponds to a selected model in the set of selected models. The one or more processors may be configured to store the set of selected models in association with the set of data points. The one or more processors may be configured to receive, from a user device, a query associated with a selected data point in the set of data points, wherein the selected data point is associated with a corresponding model in the set of selected models. The one or more processors may be configured to provide information included in the query to the corresponding model in order to receive a result associated with the selected data point. The one or more processors may be configured to transmit the result to the user device.

Some implementations described herein relate to a method of selecting from a set of models. The method may include receiving, at a model system, an indication of the set of models that are associated with a set of data points, wherein each model in the set of models was selected using a grid search. The method may include receiving, at the model system and from a user device, a query associated with a selected data point in the set of data points, wherein the selected data point is associated with a corresponding model in the set of models. The method may include providing, by the model system, information included in the query to the corresponding model in order to receive a result associated with the selected data point. The method may include transmitting, from the model system and to the user device, the result in response to the query.

Some implementations described herein relate to a non-transitory computer-readable medium that stores a set of instructions for requesting a result from a selected model out of a set of models. The set of instructions, when executed by one or more processors of a device, may cause the device to transmit a query including information associated with a selected data point, wherein the selected data point is associated with the selected model in the set of models. The set of instructions, when executed by one or more processors of the device, may cause the device to receive, in response to the query, a corresponding base value associated with the selected data point, wherein the corresponding base value is determined using the selected model. The set of instructions, when executed by one or more processors of the device, may cause the device to receive, in response to the query, a valuation for the selected data point, wherein the valuation is determined using the selected model and the information included in the query.

### BRIEF DESCRIPTION OF THE DRAWINGS

FIGS. 1A-1D are diagrams of an example implementation relating to selection from a set of models trained on different datasets, in accordance with some embodiments of the present disclosure.

FIGS. 2A-2C are diagrams of an example implementation relating to applying a selected model from a set of models trained on different datasets, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to selection from a set of models trained on different datasets, in accordance with some embodiments of the present disclosure.

FIG. 6 is a flowchart of an example process associated relating to querying a selected model from a set of models trained on different datasets, in accordance with some embodiments of the present disclosure.

### DETAILED DESCRIPTION

The following detailed description of example implementations refers to the accompanying drawings. The same reference numbers in different drawings may identify the same or similar elements.

Using machine learning models to estimate values is increasing in popularity. For example, a machine learning model may be used to calculate a valuation for a vehicle. Using a machine learning model may increase accuracy as compared with a simple linear or exponential function.

In order to further increase accuracy, more than one dataset may be used to train a machine learning model. However, building and training a complex model (whether an ensemble model based on multiple datasets or a unified model using the multiple datasets) increases computing costs exponentially. Additionally, computational costs are higher each time the model is executed.

Some implementations described herein enable training separate models from multiple data sources and using a grid search to select from the models for particular data points. For example, a dictionary may store indications of which model to use for different data points. As a result, accuracy is increased by using multiple data sources without exponential increase in computational cost because each model is trained separately. Additionally, because each data point triggers execution of a selected model, computational resources are conserved as compared with executing a more complex model.

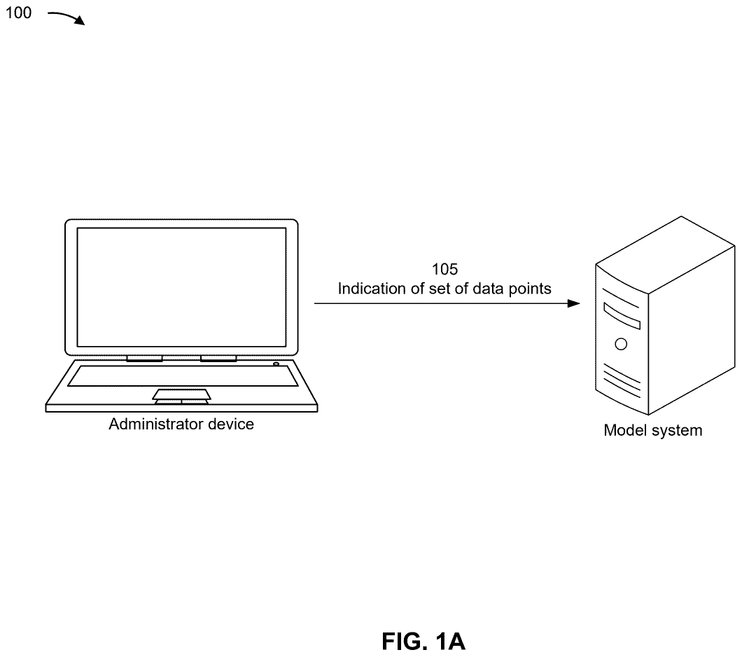

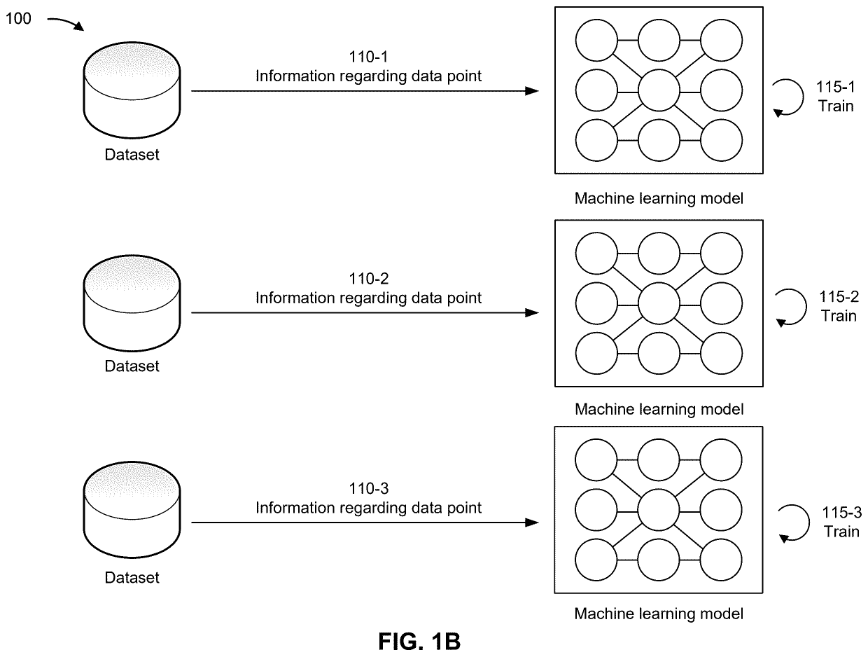

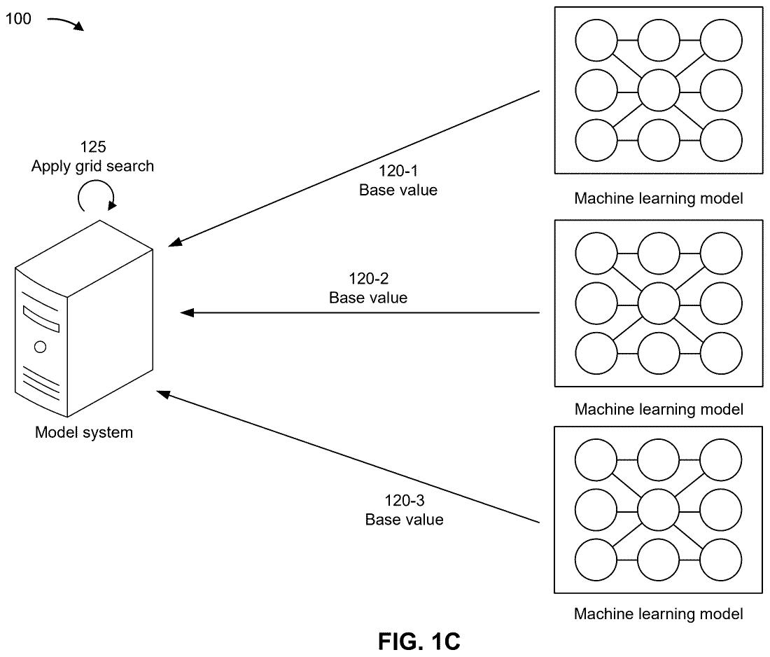

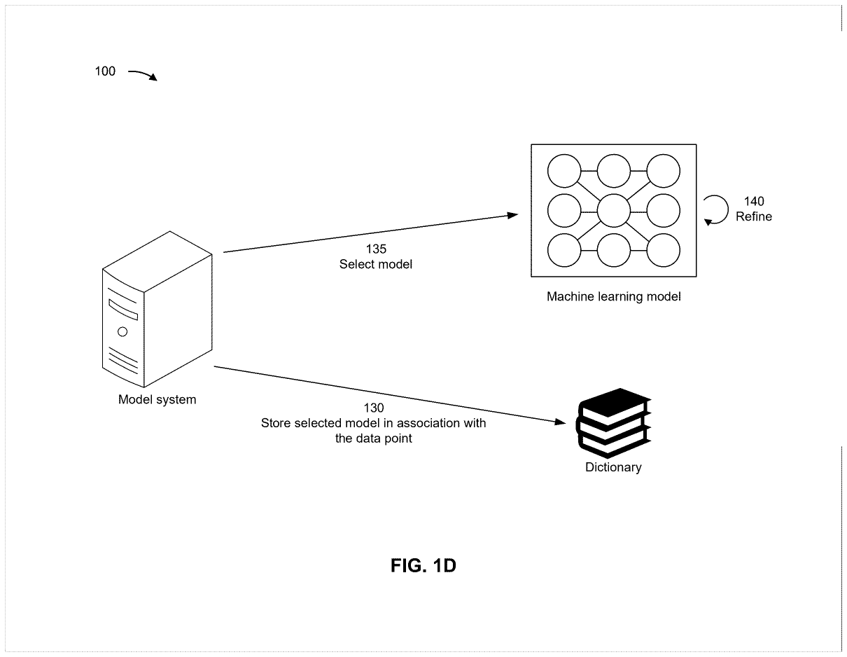

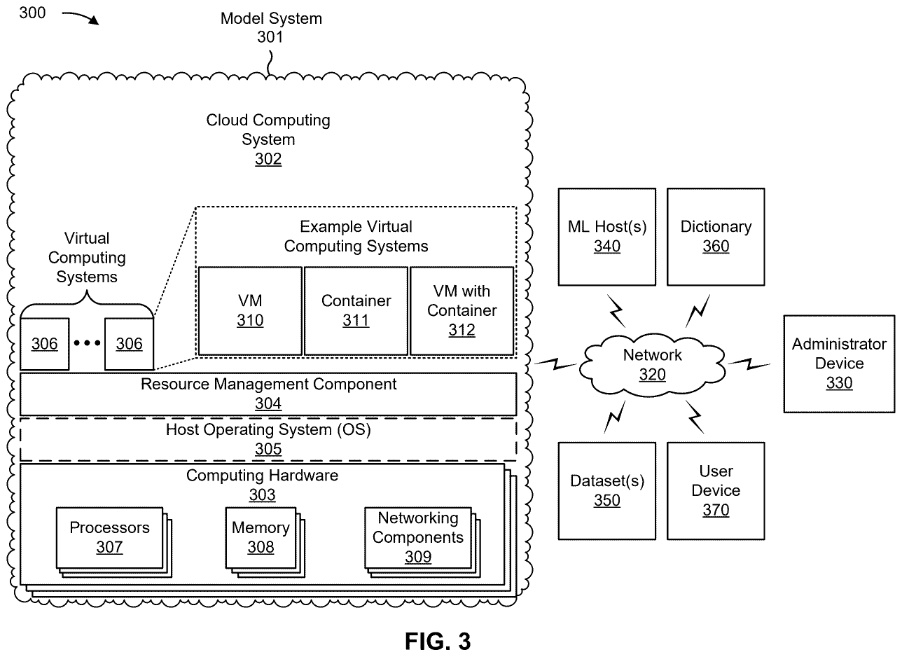

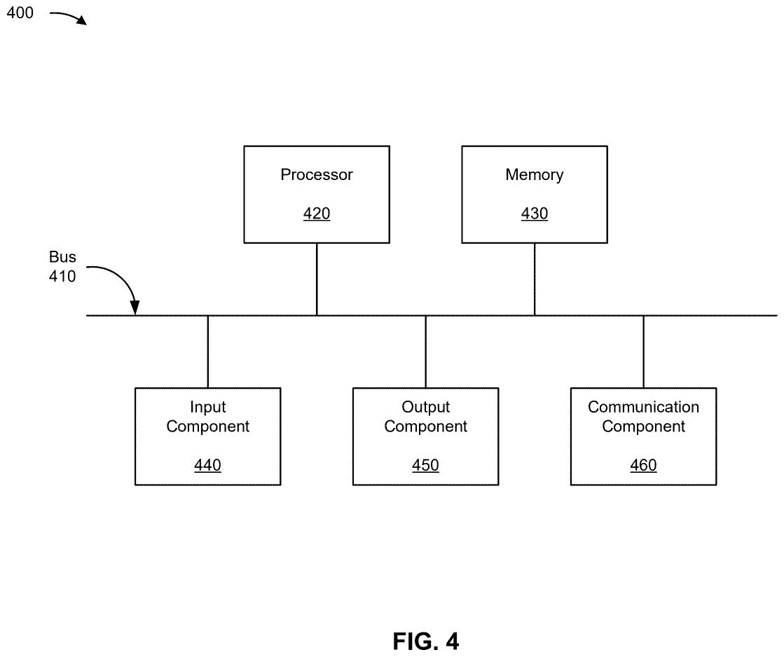

FIGS. 1A-1D are diagrams of an example 100 associated with selection from a set of models trained on different datasets. As shown in FIGS. 1A-1D, example 100 includes an administrator device, a model system, a set of datasets, a set of machine learning (ML) models (e.g., provided by a set of ML hosts), and a dictionary. These devices are described in more detail in connection with FIGS. 3 and 4.

As shown in FIG. 1A and by reference number 105, the administrator device may transmit, and the model system may receive, an indication of a set of data points. For example, the set of data points may include a set of vehicles represented by year, make, model, trim, or a combination thereof. Therefore, the administrator device may transmit, and the model system may receive, an indication of the set of vehicles. The set of data points may be encoded in a data structure (e.g., a table or another type of relational data structure, a comma separated values (CSV) file or another type of delimiter separated values (DSV) filed, among other examples) or in a plurality of data structures (e.g., a plurality of files, where each file encodes one or more data points in the set of data points).

In some implementations, an administrator using the administrator device may provide input (e.g., using an input component of the administrator device) that triggers that administrator device to transmit the set of data points. For example, the administrator device may output (e.g., using an output component of the administrator device) a user interface (UI), and the administrator may interact with the UI to provide the input that triggers that administrator device to transmit the set of data points. In another example, the administrator may provide textual input (e.g., via a command line or another type of shell) to provide the input that triggers that administrator device to transmit the set of data points.

Although the example 100 is described in connection with the administrator device providing the set of data points, other examples may include the model system automatically receiving the set of data points from a different device (e.g., a storage device). For example, the storage device may automatically transmit new data points to the model system (e.g., according to a push protocol). Alternatively, the model system may periodically request data points from the storage device (e.g., according to a pull protocol).

In some implementations, the model system may additionally receive (e.g., from the administrator device or the storage device, among other examples) an indication of a set of models. For example, each model may be associated with a different dataset, as shown in FIG. 1B. As shown by reference number 110-1, a first dataset may provide information regarding a data point in the set of data points to a first ML model. As shown by reference number 115-1, the first ML model may be trained using the information regarding the data point from the first dataset. Similarly, as shown by reference number 110-2, a second dataset may provide information regarding a data point in the set of data points to a second ML model. As shown by reference number 115-2, the second ML model may be trained using the information regarding the data point from the second dataset. Finally, as shown by reference number 110-3, a third dataset may provide information regarding a data point in the set of data points to a third ML model. As shown by reference number 115-3, the third ML model may be trained using the information regarding the data point from the third dataset. Although the example 100 is depicted using three datasets and three ML models, other examples may include fewer datasets and ML models (e.g., two datasets and two ML models) or additional datasets and ML models (e.g., three datasets and three ML models, four datasets and four ML models, and so on).

In some implementations, the ML models may include a regression algorithm (e.g., linear regression or logistic regression), which may include a regularized regression algorithm (e.g., Lasso regression, Ridge regression, or Elastic-Net regression). Additionally, or alternatively, the ML models may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML hosts (and/or devices at least partially separate from the ML hosts) may use one or more hyperparameter sets to tune the ML models. A hyperparameter may include a structural parameter that controls execution of a machine learning algorithm by an ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

Therefore, each model may be trained using a corresponding dataset in a set of datasets (e.g., the first, second, and third datasets in the example 100). Training each ML model separately conserves computing resources as compared with training an ensemble model or a unified model. Additionally, training each ML model separately reduces preprocessing of the information from the datasets because an input layer of a ML model may be customized to a format associated with the corresponding dataset.

As shown by reference numbers 120-1, 120-2, and 120-3, the model system may receive, from each ML model, a base value for the data point. For example, each ML model, after training, may generate a corresponding base value using the information regarding the data point from the corresponding dataset. As shown by reference number 125, the model system may apply a grid search (to the set of ML models) in order to generate a selected model for the data point. In some implementations, the grid search may be based on recency and quantity of data points in the corresponding datasets. For example, the model system may select the ML model that was trained using a corresponding dataset having more recent information and/or more data points as compared with the other datasets. Additionally, or alternatively, the model system may select the ML model that generates a base value that is not an outlier (e.g., a distance between the base value from the selected model and base values from the other ML models satisfies a margin of error threshold).

As shown in FIG. 1D and by reference number 130, the model system may store (an indication of) the selected model in association with (an indication of) the data point. For example, the model system may store the selected model in association with the data point in the dictionary, as shown in FIG. 1D. The association between the selected model and the data point may be encoded in a relational data structure (e.g., searchable with a structured query language (SQL) query) or a NoSQL data structure, among other examples.

In some implementations, the model system may further determine a selected base value (for the data point) using the grid search. For example, the selected base value may be output from the selected model (e.g., as described in connection with FIG. 1C). Alternatively, the selected base value may be from the corresponding dataset for the selected model. Therefore, the selected base value may be stored in association with the data point (and with the selected model). For example, the model system may store the selected base value in association with the data point in the dictionary.

As further shown in FIG. 1D, the model system may refine the selected model. For example, the model system may transmit an indication of the selected model to an ML host providing the selected model, as shown by reference number 135. Accordingly, the selected model may be refined in response to the indication of being selected, as shown by reference number 140. By selecting a single model to refine, the model system conserves computing resources as compared with refining an ensemble model or a unified model.

The operations described in connection with FIGS. 1B-1D may be repeated for each data point in the set of data points. For example, the model system may perform the grid search such that each data points, from the set of data points, corresponds to a selected model from the grid search. Accordingly, the dictionary may store (an indication of) a set of selected models associated with the set of data points. Similarly, the model system may select base values such that each data point, from the set of data points, corresponds to a selected base value from the grid search. Accordingly, the dictionary may store (an indication of) a set of selected base values associated with the set of data points.

Because the datasets and/or the ML models may be periodically updated, the model system may periodically update the model selections for the data points. For example, the model system may receive an indication that the set of ML models have been updated (e.g., from ML hosts providing the set of ML models). Additionally, or alternatively, the model system may receive an indication that the datasets have been updated (e.g., from the datasets). Therefore, in response to the indication, the model system may reapply the grid search in order to generate an updated set of selected models. For example, each data point, from the set of data points, may correspond to a selected model in the updated set of selected models. The model system may store (indications of) the updated set of selected models in association with (indications of) the set of data points (e.g., in the dictionary). Additionally, in some implementations, the model system may use the grid search in order to generate an updated set of selected base values, such that each data point, from the set of data points, may correspond to a selected base value in the updated set of selected base values. The model system may store (indications of) the updated set of selected base values in association with (indications of) the set of data points (e.g., in the dictionary).

By using techniques as described in connection with FIGS. 1A-1D, the model system generates the dictionary to dictionary to store indications of the selected models associated with the data points. As a result, accuracy is increased without exponential increase in computational cost because each model is trained separately. Additionally, each model may be separately refined for whichever data points are associated with the model, which conserves computing resources as compared with refining an ensemble model or a unified model.

As indicated above, FIGS. 1A-1D are provided as an example. Other examples may differ from what is described with regard to FIGS. 1A-1D.

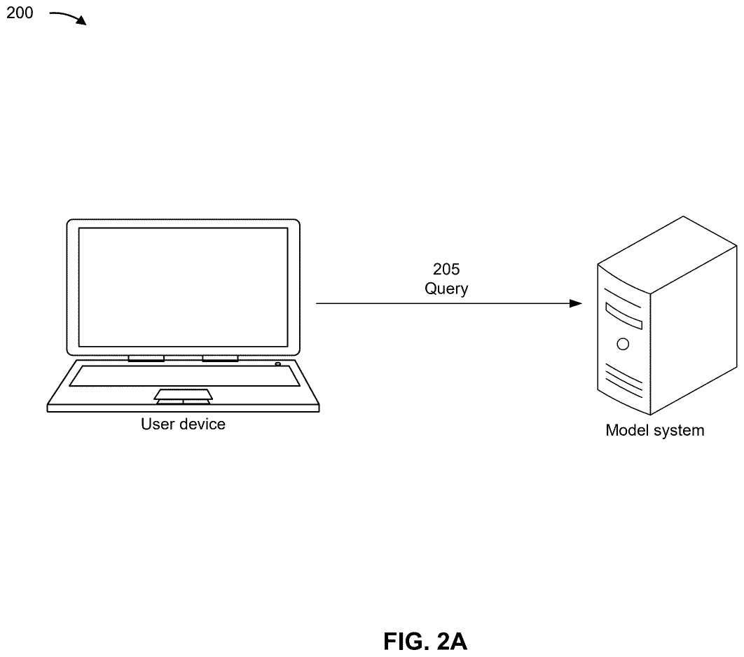

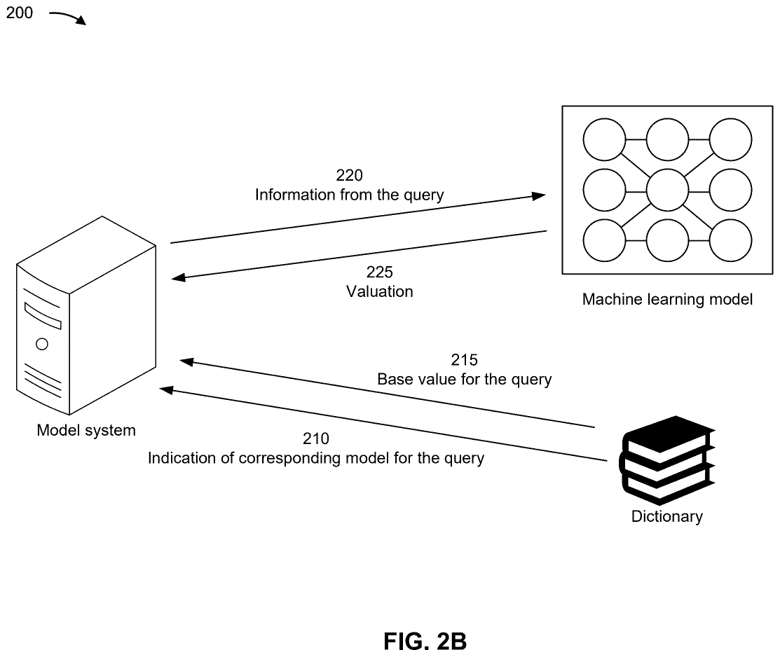

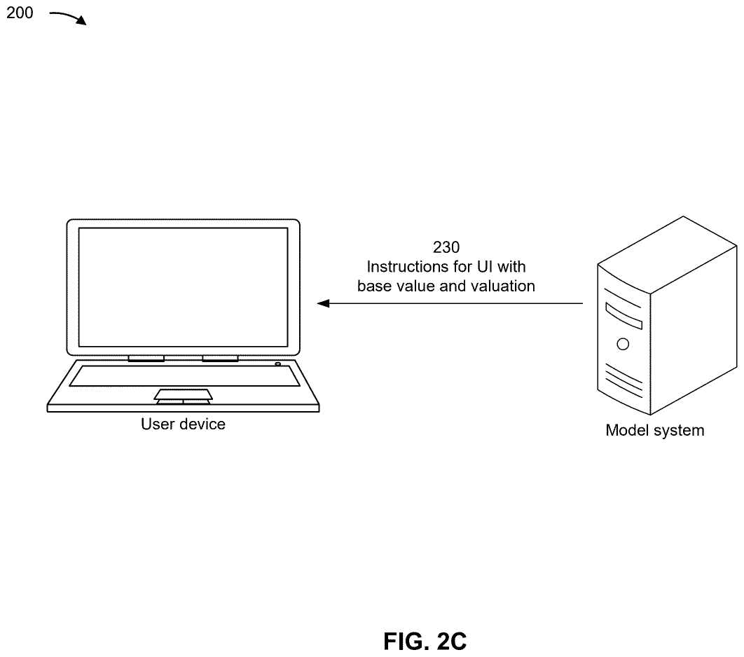

FIGS. 2A-2C are diagrams of an example 200 associated with applying a selected model from a set of models trained on different datasets. As shown in FIGS. 2A-2C, example 200 includes a user device, a model system, a corresponding ML model (e.g., provided by an ML host), and a dictionary. These devices are described in more detail in connection with FIGS. 3 and 4.

In some implementations, the model system may have generated the dictionary, as described in connection with FIGS. 1A-1D. Alternatively, the model system may receive an indication of a set of models that are associated with a set of data points (e.g., with each model in the set of models being selected using a grid search). For example, the model system may receive the indication from ML hosts associated with the set of models, from an administrator device, or from a storage device, among other examples. Additionally, in some implementations, the model system may receive an indication of a set of selected base values that are associated with the set of data points (e.g., with each selected base value in the set of selected base values being selected using the grid search). For example, the model system may receive the indication from the ML hosts associated with the set of models, from the administrator device, or from the storage device, among other examples.

As shown in FIG. 2A and by reference number 205, the user device may transmit, and the model system may receive, a query associated with a selected data point (in the set of data points). For example, the query may include a vehicle identification number (VIN). Additionally, or alternatively, the query may include a year, make, model, trim, or a combination thereof. In some implementations, information in the query may further indicate a condition, a mileage, and/or another property associated with a vehicle.

In some implementations, the user device may transmit the query using an application programming interface (API) associated with the model system. For example, a user of the user device may instruct a web browser (or another application executed by the user device) to navigate to a website hosted by (or at least associated with) the model system. Accordingly, the web browser may access the API by navigating to the website. In some implementations, the user device may provide input (e.g., using an input component of the user device) that triggers that user device to transmit the query. For example, the user device may output (e.g., using an output component of the user device) a UI (e.g., representing the website), and the user may interact with the UI to provide the input that triggers that user device to transmit the query (e.g., using the API). In another example, the user may provide textual input (e.g., via a command line or another type of shell) to provide the input that triggers that user device to transmit the query.

The selected data point may be associated with a corresponding model in the set of models (e.g., a selected model associated with the selected data point in the dictionary). Therefore, as shown in FIG. 2B and by reference number 210, the model system may receive an indication of the corresponding model from the dictionary. For example, the model system may transmit (and the dictionary may receive) a request indicating the selected data point, and the dictionary may transmit (and the model system may receive) a response including the indication of the corresponding model. The indication of the corresponding model may include a name associated with the corresponding model, an (alphanumeric) index associated with the corresponding model, an Internet protocol (IP) address associated with the ML host providing the corresponding model, and/or a medium access control (MAC) address associated with the ML host providing the corresponding model, among other examples.

In some implementations, and as shown by reference number 215, the model system may additionally receive (an indication of) a base value from the dictionary. For example, the model system may transmit (and the dictionary may receive) a request indicating the selected data point, and the dictionary may transmit (and the model system may receive) a response indicating the base value. The request for the base value may be the same request as for the corresponding model (e.g., as described above) or a separate request. Similarly, the response indicating the base value may be the same response as including the indication of the corresponding model (e.g., as described above) or a separate response. The base value may have been output from the corresponding model or may have been indicated in a dataset used to train the corresponding model, as described in connection with FIG. 1D.

As shown by reference number 220, the model system may provide the information included in the query to the corresponding model. For example, the model system may transmit, and the ML host associated with the corresponding model may receive, a request including the information. The corresponding model may generate a result associated with the selected data point using the information included in the query. For example, as shown by reference number 225, the corresponding model may output, and the model system may receive, a valuation for the selected data point. The corresponding model may thus depreciate the base value for the selected data point in order to determine the valuation. The model system may include the base value in the request, or the corresponding model may generate the base value in addition to calculating the valuation. Additionally, or alternatively, the corresponding model may adjust base value for the selected data point based on the information included in the query (e.g., the condition and/or the mileage, among other examples).

As shown in FIG. 2C, the model system may transmit, and the user device may receive, the result (e.g., the valuation) in response to the query. In some implementations, the model system may further transmit, and the user device may further receive, the base value associated with the selected data point. For example, as shown by reference number 230, the model system may transmit, and the user device may receive, instructions for a UI indicating the valuation and the base value. The UI may indicate the valuation and the base value using text and/or using a graph (e.g., a bar graph or a pie chart showing the base value, the valuation, and a difference between the valuation and the base value, among other examples).

The operations described in connection with FIGS. 2A-2C may be repeated for different data points. For example, the user device may transmit, and the model system may receive, an additional query. The additional query may include information associated with an additional data point, and the additional data point may be associated with a different model (in the set of models). Accordingly, the model system may use the dictionary to determine the different model and, optionally, an additional base value, associated with the additional data point, that was determined using the different model. Therefore, the model system may apply the different model to determine an additional result (e.g., an additional valuation) for the additional data point. The model system may transmit, and the user device may receive, the additional (e.g., the additional valuation) in response to the additional query. In some implementations, the model system may further transmit, and the user device may further receive, the additional base value associated with the additional data point. For example, the model system may transmit, and the user device may receive, instructions for an additional UI indicating the additional valuation and the additional base value.

By using techniques as described in connection with FIGS. 2A-2C, the model system executes the corresponding model for the selected data point rather than an ensemble model or a unified model. As a result, the model system conserves computing resources while still improving accuracy based on the grid search.

As indicated above, FIGS. 2A-2C are provided as an example. Other examples may differ from what is described with regard to FIGS. 2A-2C.

FIG. 3 is a diagram of an example environment 300 in which systems and/or methods described herein may be implemented. As shown in FIG. 3, environment 300 may include a model system 301, which may include one or more elements of and/or may execute within a cloud computing system 302. The cloud computing system 302 may include one or more elements 303-312, as described in more detail below. As further shown in FIG. 3, environment 300 may include a network 320, an administrator device 330, at least one ML host 340, at least one dataset 350, a dictionary 360, and/or a user device 370. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the model system 301 may include one or more elements 303-312 of the cloud computing system 302, may execute within the cloud computing system 302, and/or may be hosted within the cloud computing system 302, in some implementations, the model system 301 may not be cloud-based (e.g., may be implemented outside of a cloud computing system) or may be partially cloud-based. For example, the model system 301 may include one or more devices that are not part of the cloud computing system 302, such as device 400 of FIG. 4, which may include a standalone server or another type of computing device. The model system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The administrator device 330 may include one or more devices capable of receiving, generating, storing, processing, and/or providing information associated with data points and/or models, as described elsewhere herein. The administrator device 330 may include a communication device and/or a computing device. For example, the administrator device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 330 may communicate with one or more other devices of environment 300, as described elsewhere herein.

The ML host(s) 340 may include one or more devices capable of receiving, generating, storing, processing, providing, and/or routing information associated with machine learning models, as described elsewhere herein. The ML host(s) 340 may include a communication device and/or a computing device. For example, the ML host(s) 340 may include a server, such as an application server, a client server, a web server, a database server, a host server, a proxy server, a virtual server (e.g., executing on computing hardware), or a server in a cloud computing system. In some implementations, the ML host(s) 340 may include computing hardware used in a cloud computing environment. The ML host(s) 340 may communicate with one or more other devices of environment 300, as described elsewhere herein.

The dataset(s) 350 may include one or more devices capable of receiving, generating, storing, processing, and/or providing information associated with data points, as described elsewhere herein. The dataset(s) 350 may include a communication device and/or a computing device. For example, the dataset(s) 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The dataset(s) 350 may communicate with one or more other devices of environment 300, as described elsewhere herein.

The dictionary 360 may include one or more devices capable of receiving, generating, storing, processing, and/or providing information associated with selected models and/or selected base values, as described elsewhere herein. The dictionary 360 may include a communication device and/or a computing device. For example, the dictionary 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The dictionary 360 may communicate with one or more other devices of environment 300, as described elsewhere herein.

The user device 370 may include one or more devices capable of receiving, generating, storing, processing, and/or providing information associated with queries, as described elsewhere herein. The user device 370 may include a communication device and/or a computing device. For example, the user device 370 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 370 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with selection from a set of models trained on different datasets. The device 400 may correspond to an administrator device 330, an ML host 340, a dataset 350, a dictionary 360, and/or a user device 370. In some implementations, an administrator device 330, an ML host 340, a dataset 350, a dictionary 360, and/or a user device 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

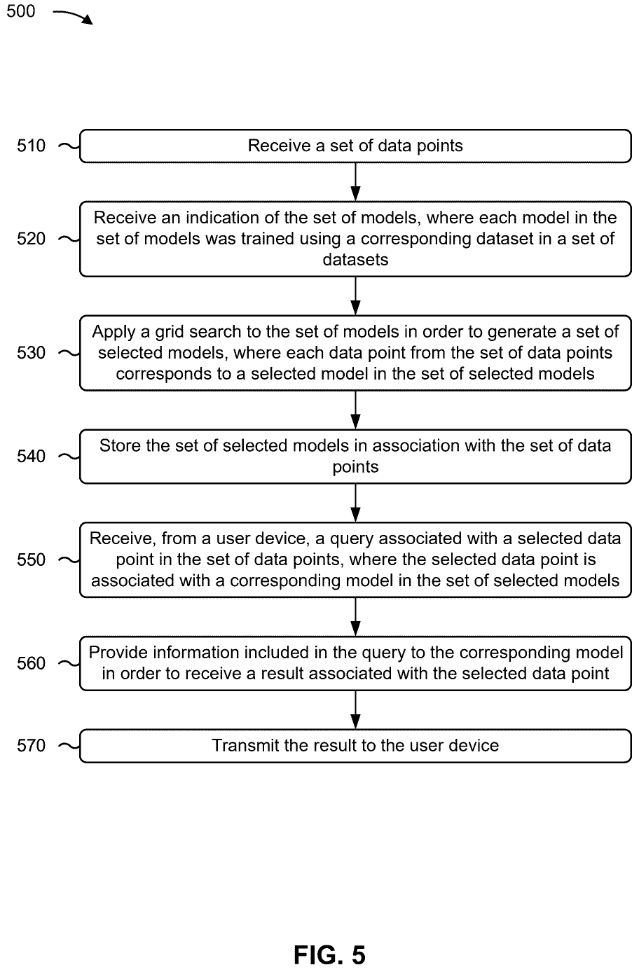

FIG. 5 is a flowchart of an example process 500 associated with selection from a set of models trained on different datasets. In some implementations, one or more process blocks of FIG. 5 may be performed by a model system 301. In some implementations, one or more process blocks of FIG. 5 may be performed by another device or a group of devices separate from or including the model system 301, such as an administrator device 330, an ML host 340, a dataset 350, a dictionary 360, and/or a user device 370. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving a set of data points (block 510). For example, the model system 301 (e.g., using processor 420, memory 430, input component 440, and/or communication component 460) may receive a set of data points, as described above in connection with reference number 105 of FIG. 1A. As an example, the set of data points may include a set of vehicles represented by year, make, model, trim, or a combination thereof. The set of data points may be encoded in a data structure (e.g., a table or another type of relational data structure, a CSV file or another type of DSV filed, among other examples) or in a plurality of data structures (e.g., a plurality of files, where each file encodes one or more data points in the set of data points).

As further shown in FIG. 5, process 500 may include receiving an indication of the set of models, where each model in the set of models was trained using a corresponding dataset in a set of datasets (block 520). For example, the model system 301 (e.g., using processor 420, memory 430, input component 440, and/or communication component 460) may receive an indication of the set of models, where each model in the set of models was trained using a corresponding dataset in a set of datasets, as described above in connection with FIG. 1A. As an example, the indication of the set of models may be encoded in a data structure (e.g., a table or another type of relational data structure, a CSV file or another type of DSV filed, among other examples) or in a plurality of data structures (e.g., a plurality of files, where each file indicates one or more models in the set of models).

As further shown in FIG. 5, process 500 may include applying a grid search to the set of models in order to generate a set of selected models, where each data point from the set of data points corresponds to a selected model in the set of selected models (block 530). For example, the model system 301 (e.g., using processor 420 and/or memory 430) may apply a grid search to the set of models in order to generate a set of selected models, where each data point from the set of data points corresponds to a selected model in the set of selected models, as described above in connection with reference number 125 of FIG. 1C. As an example, the grid search may be based on recency and quantity of data points in the corresponding datasets. For example, the model system 301 may select models that were trained using corresponding datasets having more recent information and/or more data points. Additionally, or alternatively, the model system 301 may select models that generate base values that are not outliers (e.g., a distance between a base value from a selected model and base values from other models in the set satisfies a margin of error threshold).

As further shown in FIG. 5, process 500 may include storing the set of selected models in association with the set of data points (block 540). For example, the model system 301 (e.g., using processor 420, memory 430, and/or communication component 460) may store the set of selected models in association with the set of data points, as described above in connection with reference number 130 of FIG. 1D. As an example, the model system 301 may store the set of selected models in association with the set of data points in a dictionary. The association between the set of selected models and the set of data points may be encoded in a relational data structure (e.g., searchable with an SQL query) or a NoSQL data structure, among other examples.

As further shown in FIG. 5, process 500 may include receiving, from a user device, a query associated with a selected data point in the set of data points, where the selected data point is associated with a corresponding model in the set of selected models (block 550). For example, the model system 301 (e.g., using processor 420, memory 430, and/or communication component 460) may receive, from a user device, a query associated with a selected data point in the set of data points, where the selected data point is associated with a corresponding model in the set of selected models, as described above in connection with reference number 205 of FIG. 2A. As an example, the query may include a VIN. Additionally, or alternatively, the query may include a year, make, model, trim, or a combination thereof. In some implementations, information in the query may further indicate a condition, a mileage, and/or another property associated with a vehicle.

As further shown in FIG. 5, process 500 may include providing information included in the query to the corresponding model in order to receive a result associated with the selected data point (block 560). For example, the model system 301 (e.g., using processor 420, memory 430, and/or communication component 460) may provide information included in the query to the corresponding model in order to receive a result associated with the selected data point, as described above in connection with reference number 220 of FIG. 2B. As an example, the model system 301 may transmit a request including the information to an ML host associated with the corresponding model. Accordingly, the model system 301 may receive the result from the ML host in response to the request.

As further shown in FIG. 5, process 500 may include transmitting the result to the user device (block 570). For example, the model system 301 (e.g., using processor 420, memory 430, and/or communication component 460) may transmit the result to the user device, as described above in connection with reference number 230 of FIG. 2C. As an example, the model system 301 may transmit instructions for a UI indicating the result. In some implementations, the UI may further indicate a selected base value associated with the selected data point.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and/or 2A-2C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

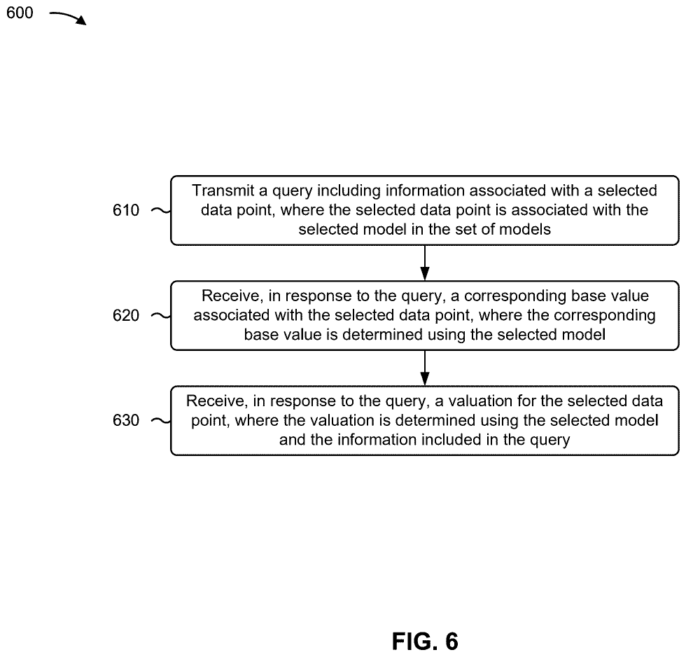

FIG. 6 is a flowchart of an example process 600 associated with querying a selected model from a set of models trained on different datasets. In some implementations, one or more process blocks of FIG. 6 may be performed by a user device 370. In some implementations, one or more process blocks of FIG. 6 may be performed by another device or a group of devices separate from or including the user device 370, such as a model system 301, an administrator device 330, an ML host 340, a dataset 350, and/or a dictionary 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting a query including information associated with a selected data point, where the selected data point is associated with the selected model in the set of models (block 610). For example, the user device 370 (e.g., using processor 420, memory 430, and/or communication component 460) may transmit a query including information associated with a selected data point, wherein the selected data point is associated with the selected model in the set of models, as described above in connection with reference number 205 of FIG. 2A. As an example, the user device 370 may transmit the query using an API associated with a model system. For example, a user of the user device may provide input (e.g., using input component 440) that triggers that user device 370 to transmit the query.

As further shown in FIG. 6, process 600 may include receiving, in response to the query, a corresponding base value associated with the selected data point, where the corresponding base value is determined using the selected model (block 620). For example, the user device 370 (e.g., using processor 420, memory 430, and/or communication component 460) may receive, in response to the query, a corresponding base value associated with the selected data point, where the corresponding base value is determined using the selected model, as described above in connection with FIG. 2C. As an example, the user device 370 may receive instructions for a UI indicating the corresponding base value. Accordingly, the user device 370 may output the corresponding base value (e.g., by outputting the UI) via output component 450.

As further shown in FIG. 6, process 600 may include receiving, in response to the query, a valuation for the selected data point, where the valuation is determined using the selected model and the information included in the query (block 630). For example, the user device 370 (e.g., using processor 420, memory 430, and/or communication component 460) may receive, in response to the query, a valuation for the selected data point, where the valuation is determined using the selected model and the information included in the query, as described above in connection with FIG. 2C. As an example, the user device 370 may receive instructions for a UI indicating the valuation. Accordingly, the user device 370 may output the valuation (e.g., by outputting the UI) via output component 450.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 2A-2C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c”is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z. ”

No element, act, or instruction used herein should be construed as critical or essential unless explicitly described as such. Also, as used herein, the articles “a” and “an” are intended to include one or more items, and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for selecting from a set of models, the system comprising:
one or more memories; and
one or more processors, communicatively coupled to the one or more memories, configured to:
receive a set of data points;
receive an indication of the set of models, wherein each model in the set of models was trained using a corresponding dataset in a set of datasets;
apply a grid search to the set of models in order to generate a set of selected models, wherein each data point from the set of data points corresponds to a selected model in the set of selected models;
store the set of selected models in association with the set of data points;
receive, from a user device, a query associated with a selected data point in the set of data points, wherein the selected data point is associated with a corresponding model in the set of selected models;
provide information included in the query to the corresponding model in order to receive a result associated with the selected data point; and
transmit the result to the user device.

2. The system of claim 1, wherein the one or more processors are configured to:
determine a set of selected base values using the grid search, wherein each data point from the set of data points corresponds to a selected base value in the set of selected base values; and
transmit a corresponding base value, in the set of selected base values, associated with the selected data point to the user device.

3. The system of claim 2, wherein the one or more processors are configured to:
store the set of selected base values in association with the set of data points.

4. The system of claim 2, wherein the set of selected base values comprise outputs from the set of selected models.

5. The system of claim 1, wherein the result comprises a valuation for the selected data point.

6. The system of claim 1, wherein the one or more processors are configured to:
receive an indication that the set of models have been updated;
reapply the grid search to the set of models in order to generate an updated set of selected models, wherein each data point from the set of data points corresponds to a selected model in the updated set of selected models; and
store the updated set of selected models in association with the set of data points.

7. The system of claim 1, wherein the set of data points comprises a set of vehicles represented by year, make, model, trim, or a combination thereof.

8. The system of claim 1, wherein the query includes a vehicle identification number.

9. A method of selecting from a set of models, comprising:
receiving, at a model system, an indication of the set of models that are associated with a set of data points, wherein each model in the set of models was selected using a grid search;
receiving, at the model system and from a user device, a query associated with a selected data point in the set of data points, wherein the selected data point is associated with a corresponding model in the set of models;
providing, by the model system, information included in the query to the corresponding model in order to receive a result associated with the selected data point; and
transmitting, from the model system and to the user device, the result in response to the query.

10. The method of claim 9, further comprising:
receiving, at the model system, an indication of a set of selected base values that are associated with the set of data points, wherein each selected base value in the set of selected base values was selected using the grid search,
wherein the selected data point is associated with a corresponding base value in the set of selected base values, and
wherein the result further includes the corresponding base value.

11. The method of claim 9, wherein the grid search is based on recency and quantity of data points.

12. The method of claim 9, wherein providing the information included in the query to the corresponding model comprises:
transmitting, from the model system and to a machine learning host associated with the corresponding model, a request including the information; and
receiving, at the model system and from the machine learning host, the result in response to the request.

13. The method of claim 9, wherein the result comprises a valuation for the selected data point.

14. The method of claim 9, wherein the information included in the query comprises a year, a make, a model, a trim, or a condition.

15. A non-transitory computer-readable medium storing a set of instructions for requesting a result from a selected model out of a set of models, the set of instructions comprising:
one or more instructions that, when executed by one or more processors of a device, cause the device to:
transmit a query including information associated with a selected data point, wherein the selected data point is associated with the selected model in the set of models;
receive, in response to the query, a corresponding base value associated with the selected data point, wherein the corresponding base value is determined using the selected model; and
receive, in response to the query, a valuation for the selected data point, wherein the valuation is determined using the selected model and the information included in the query.

16. The non-transitory computer-readable medium of claim 15, wherein the one or more instructions, when executed by the one or more processors, cause the device to:
transmit an additional query including information associated with an additional data point, wherein the additional data point is associated with a different model in the set of models;
receive, in response to the additional query, an additional base value associated with the additional data point, wherein the additional base value is determined using the different model; and
receive, in response to the query, an additional valuation for the additional data point, wherein the additional valuation is determined using the different model and the information included in the additional query.

17. The non-transitory computer-readable medium of claim 15, wherein the one or more instructions, when executed by the one or more processors, cause the device to:
output a user interface indicating the corresponding base value and the valuation.

18. The non-transitory computer-readable medium of claim 15, wherein the selected data point is associated with the selected model in the set of models based on a grid search.

19. The non-transitory computer-readable medium of claim 15, wherein the information included in the query comprises a vehicle identification number.

20. The non-transitory computer-readable medium of claim 15, wherein the information included in the query comprises a year, a make, a model, a trim, or a condition.
